(19) United States
(12) Patent Application Publication
(10) Pub. No.: US 2025/0170434 A1
(43) Pub. Date: May 29, 2025

(54) SAFETY HARNESS SYSTEMS AND METHODS

(71) Applicant: The Boeing Company, Arlington, VA (US)

(72) Inventors: Gerald Oren Pollard, Snohomish, WA (US); Alexandru Gheorghe Badger, Stanwood, WA (US)

(73) Assignee: The Boeing Company, Arlington, VA (US)

(21) Appl. No.: 18/521,299

(22) Filed: Nov. 28, 2023

(51) Int. Cl. A62B 35/00; F16D 63/00; G05B 15/02

(52) U.S. Cl. CPC A62B 35/0025; A62B 35/0018; A62B 35/0093; F16D 63/006; G05B 15/02

(57) ABSTRACT

A system and a method include a safety harness system having straps operably coupled with an object, and sensors operably coupled with the straps. The sensors detect movement of the object and transmit data associated with the movement of the object to one or more processors. The processors determine that an amount of movement of the object exceeds a movement threshold, and transmit a signal responsive to the one or more processors determining that the amount of movement of the object exceeds the movement threshold.

### FIELD OF THE DISCLOSURE

Examples of the present disclosure generally relate to personal safety harness systems and methods.

### BACKGROUND OF THE DISCLOSURE

Regulations require all people using a lift system (e.g., aerial work platforms, bucket lifts, boom lifts, paint stackers, scissor lifts, etc.) to be wearing a safety protection harness that is to be connected to the lift system so that the occupant may not fall from the lift. Occupants may connect their harness to the lift using either a fixed-length lanyard or a self-retracting lanyard (SRL). Single-lead fixed-length lanyards are preferred when occupants do not need to leave the safety of the lift to do work. Dual-lead fixed-length lanyards enable occupants to keep one lead attached to the lift while connecting the second lead to an external anchor. SRL systems are used when occupants must leave the lift to do work and external anchors are not available to connect to.

If an occupant using a fixed-length lanyard falls from a lift, their fall distance is limited by the length of the lanyard connecting their safety harness to the lift. Whereas if an occupant using an SRL falls from a lift, their fall distance is limited by the length of the lanyard extending from the SRL prior to the fall plus the additional length of lanyard extended from the SRL prior to SRL lockup. The Occupational Safety and Health Administration (OSHA) requires the maximum free fall to be no more than six feet.

One or more locking components within the SRL move between an unlocked state and a locked state based on mechanical forces acting on the system. For example, when an occupant falls the lanyard is pulled out of the SRL at a rate proportional to the weight of the occupant. The centrifugal forces acting on the locking pawls in the SRL cause the locking pawls to overcome spring tension and rotate outwards to the locked position. When the locking pawls engage the ratchet latches, the rotation of the SRL is stopped and no additional lanyard can be extended. The total length of the fall is equal to the sum of length of the lanyard that was extended prior to the fall and the additional length of the lanyard extended before the SRL detected the fall and locked up.

The mechanic design of existing SRLs require a person (or object) to fall for a length of time (or distance) before the centrifugal forces acting on the locking components can move the locking components to the locked state. The length of time and distance that the person falls before the locking components move to the locked state and stop travel of the retractable safety strap may cause significant rebound and shock forces to act on the person once travel of the retractable safety strap is stopped. For example, the SRL may stop the person (or object) from falling, but due to the speed developed during the fall, the rebound forces acting on the occupant may cause injury.

### SUMMARY OF THE DISCLOSURE

A need exists for an SRL harness system and method that automatically determines that a person (or object) operably coupled with straps of the safety harness system has moved more than an allowable movement threshold, and automatically transmits a signal to control a locking component of a SRL operably coupled with the safety harness system.

Further, a need exists for a smart safety harness system that can learn and determine the performance capabilities of different objects that may be coupled with the safety harness system, along with anticipated or expected movements or motions of the objects, and the like, and automatically determine when an amount of movement or motion of the object exceeds an allowable movement or motion threshold.

By using algorithms personalized for each user and/or object, emanate falls can be detected and stopped before they occur while enabling users the maximum amount of freedom of movement without nuisance lockups.

With those needs in mind, certain examples of the present disclosure provide a safety harness system and method that includes one or more straps that are coupled with an object (e.g., an operator or other object) and operably coupled with a fall protection system. One or more sensors are coupled with the one or more straps and detect movement of the object. The safety harness system also includes one or more processors operably coupled with the straps and configured to receive data from the sensors associated with the movement of the object. The processors determine that an amount of movement of the object exceeds a movement threshold, and transmit a signal responsive to determining that the amount of movement of the object exceeds the movement threshold.

In one example, the processors may be operably coupled with the fall protection system, and the processors may transmit the signal to the fall protection system responsive to determining that the movement of the object exceeds the movement threshold. For example, the processors may be electrically coupled with one or more systems or components of the fall protection system, and may transmit the signal to the fall protection system responsive to determining that the amount of movement of the object exceeds the movement threshold.

In at least one example, the signal may control movement of an extension member of the fall protection system to move the extension member between a first position and a second position. The extension member moving between the first position and the second position may change a state of a locking component of the fall protection system between an unlocked state and a locked state. In another example, the straps may be operably coupled with the fall protection system via a retractable lanyard extending between the straps and the fall protection system. The extension member moving between the first position and the second position based on the signal controls an amount of travel of the retractable lanyard.

In at least one example, the processors may receive a first set of data from the sensors associated with movement of the object within a first time range, and may determine that the amount of movement of the object exceeds the movement threshold based at least in part on the first set of data. Optionally, the processors may receive a second set of data from the sensors associated with movement of the object within a second time range. The processors may compare the first set of data with the second set of data and determine that the amount of movement of the object exceeds the movement threshold based at least in part on the comparison between the first set of data and the second set of data.

In at least one example, the safety harness system may also include a memory or other storage system that may store historical data detected by the one or more sensors. The processors may determine that the amount of movement of the object exceeds the movement threshold based at least in part on the historical data.

In at least one example, the processors may transmit the signal to an emergency system. For example, the processors may transmit the signal to an emergency dispatch center, a paramedics center, a control center, or the like. The signal may include a location of the sensors and/or the straps, and/or a time stamp associated with a time at which the processors determined that the amount of movement of the object exceeded the movement threshold. For example, if the object moves beyond the allowable movement threshold, the object (e.g., operator or other object coupled with the straps) may be injured, damaged, or the like. The signal may be an emergency signal to emergency services indicating the location where the object may be located, information associated with how much the object moved (e.g., how far the object fell), the time at which the object fell or moved beyond the movement threshold, or the like, such as to provide information to the emergency services.

In at least one example, the processors may determine that the amount of movement of the object within a determined time range exceeds a movement rate threshold. For example, the object may move a first amount at a first time within the determined time range, and move a second amount at a second time that is outside of the determined time range. The processors may determine that the amount of movement does not exceed the movement rate threshold based on the second amount of movement being outside of the determined time range. Alternatively, the processors may determine that the amount of movement does exceed the movement rate threshold if the second amount of movement occurred during the determined time range.

In at least one example, the processors may be operably coupled with the fall protection system (and/or another device or system) via a wired and/or wireless connection. For example, the processors may transmit the signal to the fall protection system via a wireless connection between the processors and the fall protection system. The processors may be wirelessly coupled with the fall protection system via one or more known wireless connection protocols. Alternatively, the processors may transmit the signal to the fall protection system via a wired connection between the processors and the fall protection system.

Certain examples of the present disclosure provide a method that includes detecting movement of an object operably coupled with one or more straps of a safety harness system, determining that an amount of movement of the object exceeds a movement threshold, and transmitting a signal responsive to determining that the amount of movement of the object exceeds the movement threshold. Transmitting the signal may include controlling operation of a fall protection system based at least in part on the signal.

Certain examples of the present disclosure provide a safety harness system that includes straps operably coupled with an object and operably coupled with a fall protection system; and sensors operably coupled with the straps. The sensors detect movement of the object. The safety harness system also includes processors operably coupled with the straps and configured to receive data from the sensors associated with the detected movement of the object. The processors may also be electrically coupled with the fall protection system. The processors determine that an amount of movement of the object exceeds a movement threshold, and transmit a signal to the fall protection system responsive to determining that the amount of movement of the object exceeds the movement threshold. The signal changes a state of a locking component of the fall protection system between an unlocked state and a locked state.

### BRIEF DESCRIPTION OF THE DRAWINGS

FIG. 1 illustrates a front view of an example of a safety harness system, according to an example of the present disclosure.

FIG. 2 illustrates a rear view of the safety harness system shown in FIG. 1, according to an example of the present disclosure.

FIG. 3 illustrates a schematic of a controller of a safety harness system, according to an example of the present disclosure.

FIG. 4 illustrates a schematic of a safety harness system operably coupled with a fall protection system, according to an example of the present disclosure.

FIG. 5 illustrates a flow chart of a method, according to an example of the present disclosure.

FIG. 6 illustrates a partial cross-sectional view of a fall protection system in a first state, according to an example of the present disclosure.

FIG. 7 illustrates a partial cross-sectional view of a fall protection system in a second state, according to an example of the present disclosure.

FIG. 8 illustrates a partial cross-sectional view of a fall protection system in a third state, according to an example of the present disclosure.

FIG. 9 illustrates an example of a timeline, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

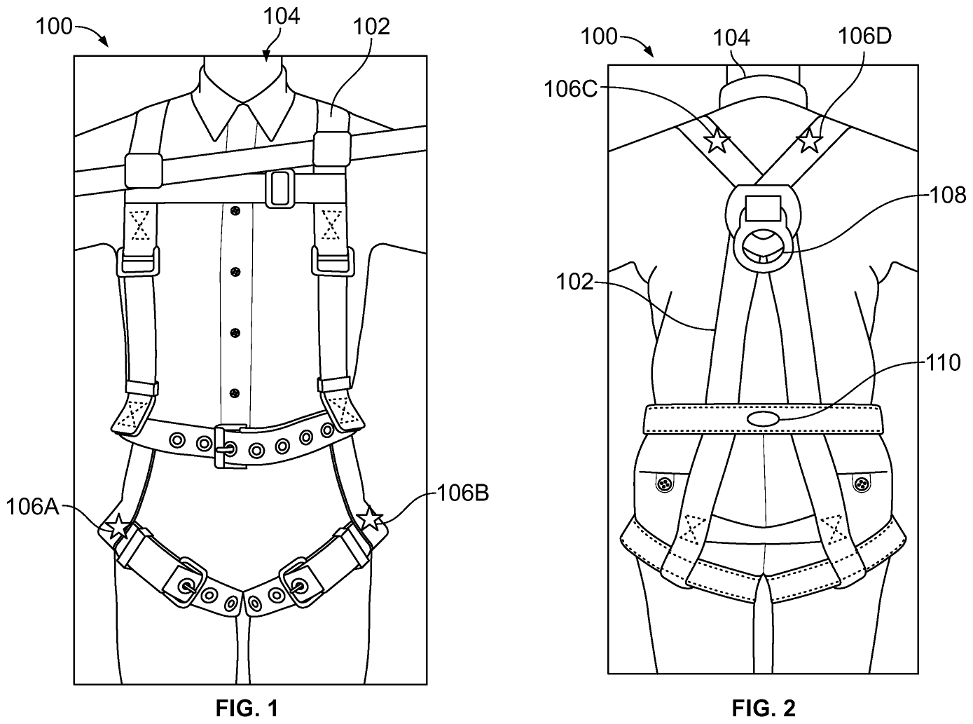

FIG. 1 illustrates a front view of a safety harness system 100 and FIG. 2 illustrates a rear view of the safety harness system 100 in accordance with one example of the present disclosure. In the illustrated example, the safety harness system 100 includes plural straps 102 that are operably coupled with and extend around an object 104. In one example, the object 104 may be a person, or in another example, the object may be a piece of equipment, machinery, or any alternative structure or component.

In one example, the object 104 may be a person using the safety harness system 100. As one example, the person may be disposed within a lift system (not shown) that may move the person between different elevations so that the person may perform maintenance and/or inspection on a structure, such as a building, an aircraft system, utility equipment, or the like. Optionally, the lift system may be an elevated stationary platform on which the person may be disposed, such as to perform work at an elevated position. In one or more examples, the lift system may be a mobile elevating work platform or a stationary elevating work platform such as, but not limited to, an aerial work platform, a cherry picker, a bucket lift, a boom lift, a paint stacker, a scissor lift, or the like. As another example, the object 104 may be a component using the safety harness system 100. The component may be moved to different positions, such as via a lift system (not shown), to move the component to different locations (e.g., different elevations, different lateral positions, or the like). The safety harness system 100 may be coupled with a person and/or structure while the person and/or object is positioned and/or moved to one or more elevated positions (e.g., above a ground level).

The safety harness system 100 includes a connector 108 that may be used to connect the safety harness system 100 with the lift system. For example, a tether or other strap system (not shown in FIGS. 1 and 2) may extend between the connector 108 and the lift system (not shown) to connect the safety harness system 100 with the lift system and may prevent the object 104 from falling beyond a length of the tether if the object falls out of the lift basket.

The safety harness system 100 includes one or more sensors 106A-D that are operably coupled with the one or more straps 102. The sensors may include position sensors, accelerometers, gyroscopes, magnetometers, inertial measurement sensors, cameras and/or video motion sensors, proximity sensors, vibration sensors, ultrasonic transducers, or the like. In one or more examples, one or more of the sensors may be operably coupled with and/or embedded within the one or more straps 102 of the safety harness system 100 at different locations of the straps 102. In one example, one or more of the sensors 106A-D may be retroactively added to and/or coupled with one of the straps 102 of the safety harness system 100. In another example, one or more of the sensors 106A-D may be embedded within the straps 102 of the safety harness system 100 during the manufacture and/or fabrication of the safety harness system 100.

In one or more examples, one or more of the sensors 106A-D may be capable of sensing and/or detecting characteristics at a sample rate of about 100 samples per second, about 1,000 samples per second, about 4,000 samples per second, or the like.

The different sensors 106A-D may be disposed at different locations of the safety harness system 100. The different sensors 106A-D may detect different motion and/or other characteristics associated with different portions of the object to which the safety harness system 100 is coupled. For example, the sensors 106A and 106B that are operably coupled with a front portion of the safety harness system 100 may be sensors that detect motion associated with the legs of the object 104 (e.g., the operator or person wearing the safety harness system 100). The sensor 106C and 106D operably coupled with a rear portion of the safety harness system 100 may detect motion associated with arms of the object 104. The one or more different sensors 106A-D may be placed and/or coupled with the straps 102 at different locations of the straps 102 based on one or more of the type of sensor; the type, shape, and/or size of the object; a weight of the object; or the like.

The safety harness system 100 also includes a controller 110 that is operably coupled with the straps 102. In the illustrated example, the controller 110 is operably coupled with the straps 102 at the rear portion of the safety harness system 100, but alternatively may be placed at another location of the safety harness system 100. In one or more examples, the controller may be operably coupled with the sensors 106A-D such that the controller may receive data from the one or more sensors 106A-D. One or more of the sensors 106A-D may transmit detected data to the controller via one or more wires (not shown) extending between the controller and the one or more sensors 106A-D. Optionally, one or more of the sensors may be wirelessly coupled with the controller and may wirelessly transmit the detected data to the controller. In one or more examples, the controller may be communicatively linked with each of the sensors 106A-D (via wired and/or wireless communication links) to allow the controller to control operation of the sensors, to communicate with the sensors, or the like.

In one example, the controller 110 may be retroactively coupled with the straps (e.g., after the safety harness system 100 has been fabricated, manufactured, and/or used in operation), and/or the controller 110 may be coupled with the straps 102 while the safety harness system 100 is being fabricated and/or manufactured. The placement of the controller 110 may be based on a general center of mass of the object 104 while the object is coupled with the straps 102, based on the type, shape, and/or size of the object, based on the placements and/or types of the different sensors 106A-D, or any combination therein.

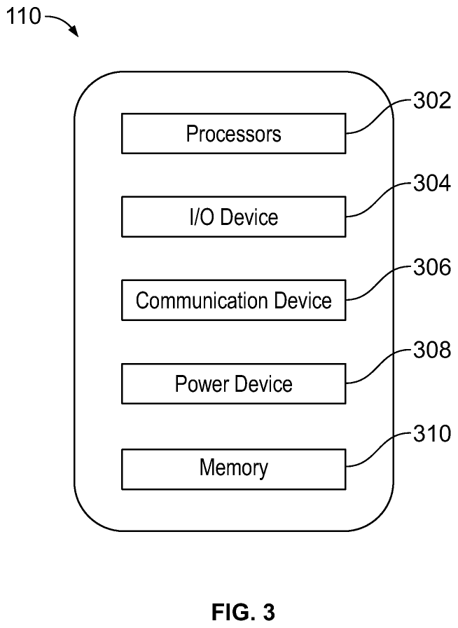

FIG. 3 illustrates a schematic of the controller 110 of the safety harness system, in accordance with one example of the present disclosure. The controller 110 shown in FIG. 3 is merely exemplary, and non-limiting. As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the controller 110 may be or include one or more processors that are configured to control operation, as described herein.

The controller 110 includes one or more processors 302, such as one or more microprocessors, field programmable gate arrays, integrated circuits, and/or the like. In one example, the controller may include a single processor or multiple processors. All operations can be performed by each processor, or each processor may perform at least one different operation than one or more (or all) other processors.

The controller 110 also includes one or more input and/or output devices 304 (shown as “I/O Device(s) in FIG. 3). For example, the controller may include an audio and/or visual alerting system (e.g., a light that flashes, a speaker, a vibrating component, or the like) that communicates information with the object 104. Optionally, the input and/or output devices may include a touch controller, a switch, a wheel, or the like, that allows the object 104 (e.g., the person or operator) to communicate with the controller 110.

In one or more examples, the controller 110 can include a communication device 306 that represents transceiving hardware (e.g., antennas, wires, cables, modems, codecs, or the like) that can wirelessly communicate signals or communicate signals described herein via wired connections. The communication device 306 may communicate with the object 104 operably coupled with the safety harness system, with another person or operator positioned proximate to the safety harness system 100 (e.g., another person in a lift basket), with one or more operators at a control center (not shown), with an emergency response center (e.g., an emergency dispatch center, a paramedics group, a fire station, etc.) or the like.

The controller 110 also includes a power device 308, that can represent one or more batteries, fuel cells, or the like, that may provide power to one or more systems and/or components of the safety harness system 100.

In one or more examples, the controller 110 can also include a memory 310 in communication with the one or more processors 302. The memory 310 can store instructions, received data (e.g., from the one or more sensors 106A-D), and/or generated data.

The controller 110 is configured to execute a set of instructions that are stored in the memory 310 and/or one or more other data storage units or elements in order to process data. The memory 310 and/or the data storage units may also store data or other information as desired or needed. The memory 310 may be in the form of an information source or a physical memory element within a processing machine.

The set of instructions may include various commands that instruct the controller 110 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the controller 110. It is to be understood that the processing or controllers may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the controller 110 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

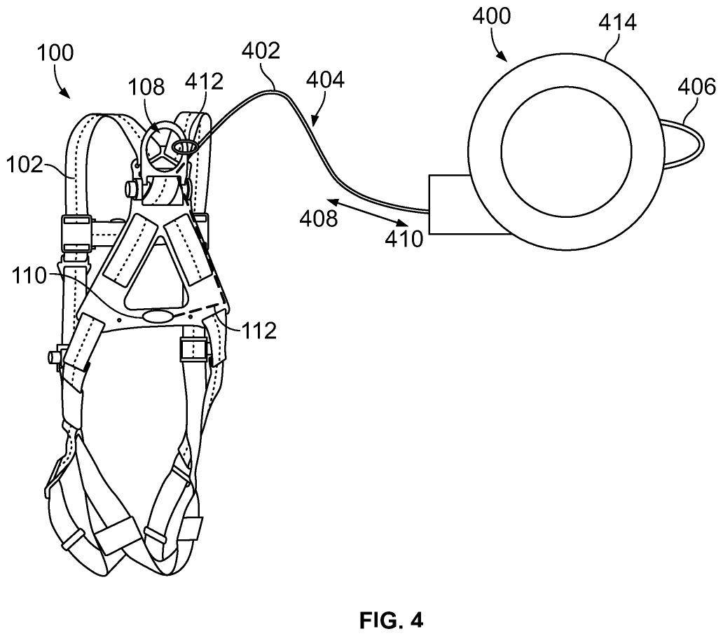

FIG. 4 illustrates a schematic of the safety harness system 100 operably coupled with a fall protection system 400, in accordance with one example of the present disclosure. In the illustrated example, the fall protection system 400 includes a retractable lanyard 402 that extends between a housing 414 of the fall protection system and the connector 108 of the safety harness system 100. The retractable lanyard includes a coupling feature 412 that connects the lanyard to the connector 108. The retractable lanyard is arranged to move in a first direction 408 out of and away from the housing 414 or in a second direction 410 into the housing 414. In one or more examples, the fall protection system 400 may be referred to as a self-retracting lifeline (SRL). For example, the self-retracting lifeline may be a safety lifeline for the object 104 operably coupled with the safety harness system 100 and to control a distance that the object 104 may be allowed to fall if the object 104 becomes separated from the lift system (not shown) to which the self-retracting lifeline is coupled.

In one example, the safety harness system 100 includes one or more wires 112 that extend between the controller 110 and one or more cables 404 disposed within or operably coupled with the retractable lanyard 402. For example, the wires 112 electrically connected with the cables 404 provides an electrical connection between the controller 110 and one or more components or systems of the fall protection system 400.

In one example, the housing 414 of the fall protection system 400 includes an anchoring component 406 that allows the fall protection system 400 to be anchored to a stabilizing component (e.g., a lift system, a lift basket, an alternative anchoring structure, or the like).

In one or more examples, a locking system (not shown) may be disposed between the safety harness system 100 and the fall protection system 400. For example, the safety harness system 100 may be operably coupled with (e.g., mechanically and electrically) with a locking system, and the fall protection system 400 may be operably coupled with (e.g., mechanically and electrically) with the locking system such that the locking system operably couples the safety harness system 100 with the fall protection system 400. For example, data and/or electrical signals may be passed through the locking system between the safety harness system 100 and the fall protection system 400 to allow the safety harness system 100 to communicate with the fall protection system 400.

In one example, power may be passed through the locking system between the safety harness system 100 and the fall protection system 400. For example, the fall protection system 400 may be electrically coupled with a power device of a lift system (not shown) and may pass electrical current through the locking system to the safety harness system 100 to provide power to the controller 110, the sensors 106A-D, and/or one or more other systems of the safety harness system 100.

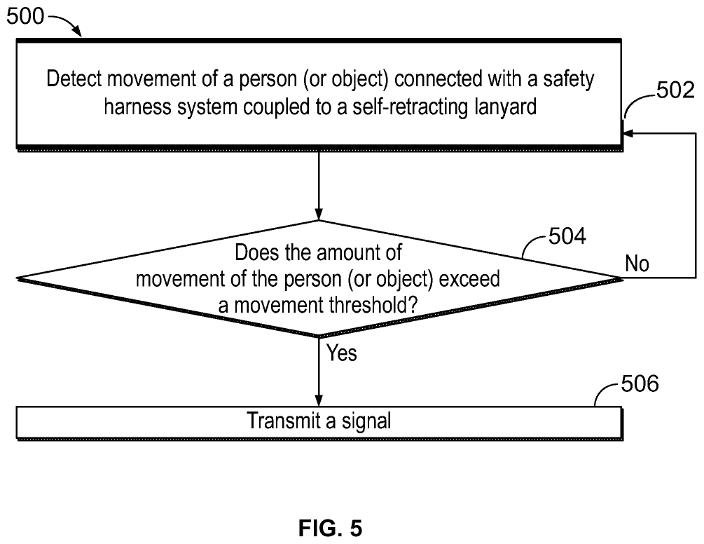

In one or more examples, the controller 110 of the safety harness system 100 may be operably coupled with the fall protection system 400 to control one or more operations of the fall protection system 400. FIG. 5 illustrates one example of a flowchart 500 of a method, such as for controlling operation of the fall protection system 400 with the safety harness system 100, in accordance with one example of the present disclosure. The method includes detecting movement 502 of the object 104 operably coupled with the safety harness system 100. For example, the sensors 106A-D may continuously monitor the object and obtain data associated with movement of the object 104. The one or more processors 302 of the controller 110 may receive the sensed data from the sensors 106A-D associated with movement of the object 104. In one example, the one or more processors 302 may receive data from the sensors 106A-D at a rate of about 100 samples per second, about 1,000 samples per second, about 4,000 samples per second, or the like.

The one or more processors 302 may determine if an amount of movement 504 of the object 104 exceeds a movement threshold. In one or more examples, the one or more processors 302 may be capable of analyzing the data from the sensors 106A-D at a rate of about 100 executions per second, about 1,000 executions per second, about 1,500 executions per second, about 3,000 executions per second, or the like.

In one or more examples, the movement threshold may be associated with a rate of acceleration of the object, a velocity of the object, a total distance of movement of the object, a distance of movement over a determined time period (e.g., within about 10 milliseconds, about 100 milliseconds, about 1 second, about 5 seconds, or the like), or the like. In one example, the one or more processors 302 may determine if the amount of movement of the object 104 within a determined time range exceeds a movement rate threshold associated with the determined time range. For example, the time range may be a length of about 10 milliseconds, about 100 milliseconds, about 1 second, about 5 seconds, or the like.

If the amount of movement does not exceed a determined movement threshold, a determined movement rate threshold, or the like, then flow of the method returns to 502 and the sensors 106A-D continue to provide sensed data to the one or more processors 302 associated with movement of the object. The sensors 106A-D may continue to provide sensed data to the one or more processors until the object 104 returns to a determined elevation level (e.g., ground level). Alternatively, if the amount of movement of the object 104 is determined to exceed the determined movement threshold, the one or more processors 302 transmit a signal 506 responsive to determining that the amount of movement of the object exceeded the movement threshold.

In one example, the one or more processors 302 may automatically transmit the signal to the fall protection system 400 to control operation of the fall protection system 400. For example, the signal may be and/or include an electrical current that may be transmitted to the fall protection system to change a state of one or more components of the fall protection system 400. The signal may be transmitted via the wires 112 and 404 to the fall protection system 400, or maybe wireless transmitted to the fall protection system 400 via one or more wireless communication systems and/or protocols.

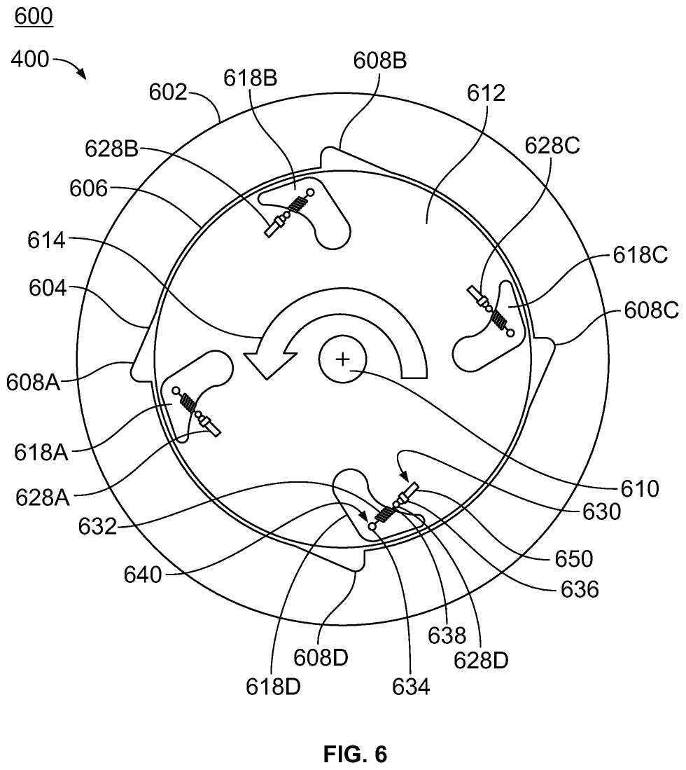

FIG. 6 illustrates a partial cross-sectional view of the fall protection system 400, in accordance with one example. In the illustrated example, the fall protection system 400 includes a housing 602 that includes one or more interior surfaces 604 that define a cavity 606. The housing 602 extends about an axis 610. The housing 602 includes one or more engagement features 608A-D. In the illustrated example, the engagement features 608A-D are recesses, divots, concave features, etc., that extend into the surfaces 604 of the housing that define the cavity 606 and away from the axis 610. In one example, the engagement features 608A-D may be referred to as ratchet latches. In alternative examples, the engagement features may have alternative shapes, sizes, positions, or the like.

The fall protection system 400 includes a rotating device 612 that is disposed within the cavity 606 of the housing 602. In the illustrated example, the rotating device has a shape and size that is substantially the same as the shape and size of the cavity 606. The retractable lanyard 402 (shown in FIG. 4) is operably coupled with the rotating device 612 such that rotation of the rotating device 612 directs the lanyard in the first and second directions 408, 410 out of and into the fall protection system 400, respectively. For example, the rotating device 612 rotates in a first direction of rotation 614 responsive to the lanyard moving in the first direction 408 out of and away from the fall protection system 400.

The fall protection system 400 includes one or more locking components 618A-D that are operably coupled with the rotating device 612. The locking components 618A-D are shaped and sized to correspond to the shape and size of the engagement features 608A-D of the housing 602. The locking components 618A-D are operably coupled with the rotating device 612 such that the locking components 618A-D rotate about the axis 610 based on the rotation of the rotating device 612, and each of the locking components 618A-D are free to rotate about a corresponding locking axis (not shown) of each locking component 618A-D. For example, if the rotational speed of the rotating device 612 exceeds a threshold, each of the locking components 618A-D may rotate about a corresponding locking axis based on the inertia acting on the locking components 618A-D. In one example, the locking components may be referred to as locking pawls that may rotate outward to engage the engagement features.

Each of the locking components 618A-D is operably coupled with a corresponding resilient assembly 628A-D. For example, the resilient assembly 628A is operably coupled with the locking component 618A, the resilient assembly 628B is operably coupled with the locking component 618B, the resilient assembly 628C is operably coupled with the locking component 618C, and the resilient assembly 628D is operably coupled with the locking component 618D.

Each resilient assembly 628A-D includes an extension member 630 and a spring device 632 that is coupled with the corresponding extension member 630. Each spring device 632 extends between a first end 638 that is coupled with a second end 636 of the corresponding extension member 630, and a second end 640 that is coupled with the corresponding locking component 618A-D. The extension members 630 may also be referred to as extension pins and may be operably coupled with one or more solenoid devices (not shown).

The fall protection system 400 shown in FIG. 6 is merely exemplary, and non-limiting. For example, the illustrated embodiment of the fall protection system 400 includes four engagement features 608A-D, four locking components 618A-D, and four resilient assemblies 628A-D. In alternative embodiments, the fall protection system 400 may include less than four or more than four of one or more of the engagement features, the locking components, and/or the resilient assemblies.

In the illustrated example shown in FIG. 6, the fall protection system 400 is in a first state 600, which may be referred to as an unlocked state. For example, while the fall protection system 400 is in the first state 600, the rotating device 612 is free to rotate about the axis 610 of the housing in the first direction of rotation 614 thereby allowing the retractable lanyard to move in the first direction 408 out of the housing 602 of the fall protection system 400. The state of the fall protection system 400 may change from the first state (e.g., the unlocked state) to a first locked state or a second locked state responsive to one or more mechanical or electrical inputs. For example, the retractable lanyard 402 may be prohibited from moving in the first direction 408 out of the housing 602 responsive to the state of the fall protection system 400 changing from the unlocked state to the first or second locked states. The fall protection system 400 in the first and second locked states controls an amount of travel of the retractable lanyard 402 in the first direction 408.

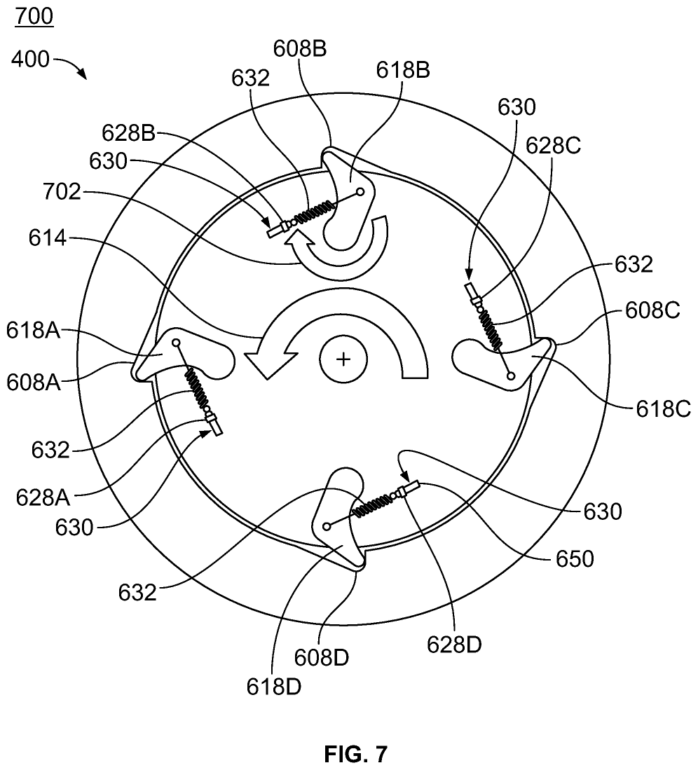

As one example, FIG. 7 illustrates a partial cross-sectional view of the fall protection system 400, in accordance with another example. In the illustrated example shown in FIG. 7, the fall protection system 400 is in a second state 700, which may be referred to as a first locked state. The fall protection system 400 may move to the second state 700 based on one or more mechanical inputs. For example, while the locking components 618A-D rotate with the rotating of the rotating device 612, the spring devices 632 (e.g., which may be compression springs) attempt to pull the corresponding locking component 618A-D back to a compressed state. However, a speed of rotation of the rotating device 612 in the first direction of rotation 614 may reach a limit. In one or more examples, a rotational energy acting on one or more of the locking components 618A-D may cause the locking components 618A-D to overcome tension from the corresponding spring devices 632 and rotate outward in a second direction of rotation 702 and engage one or more of the engagement features 608A-D of the housing 602 responsive to the speed of rotation of the rotating device 612 reaching a limit.

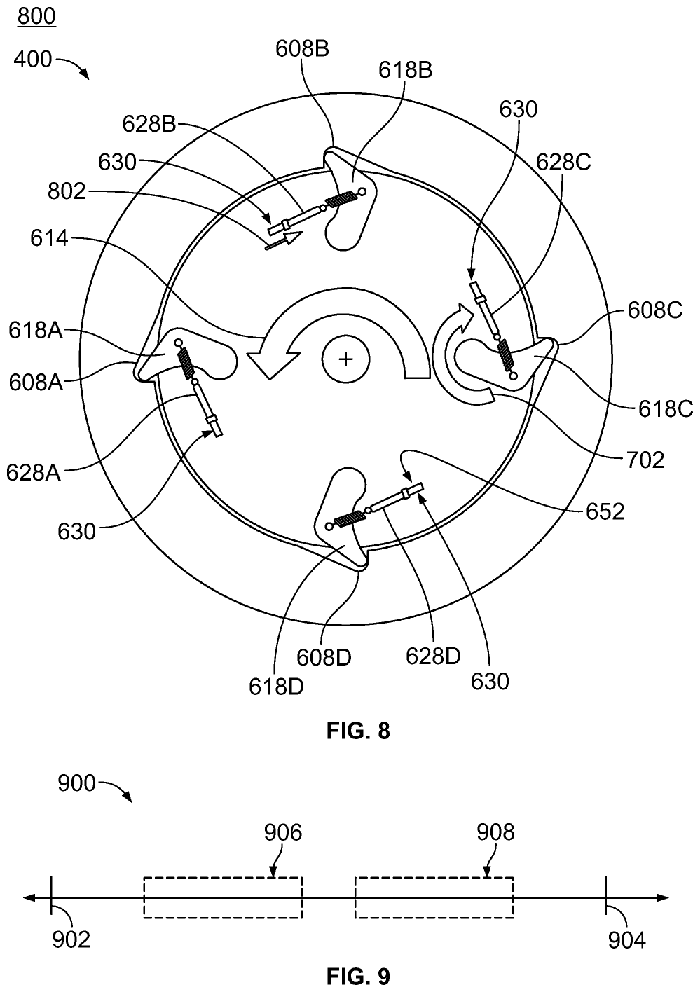

As another example, FIG. 8 illustrates a partial cross-sectional view of the fall protection system 400, in a third state 800, which may be referred to as a second locked state. The fall protection system 400 may move from the first state 600 (e.g., unlocked state) to the third state 800 based on one or more electrical inputs. For example, the fall protection system 400 may move to the third state 800 responsive to the controller 110 of the safety harness system 100 transmitting a signal to the fall protection system 400. As one example, the controller 110 of the safety harness system 100 may be operably coupled with the another component of the fall protection system 400 (e.g., one or more solenoid devices, not shown) via one or more wired and/or wireless connections to control operation of the solenoid devices. The controller 110 may determine that the speed of movement of the object 104 exceeds a movement threshold based on data received by the controller 110 from the one or more sensors 106A-D and may transmit a signal to the fall protection system 400. In one or more examples, the signal may be an electrical signal that may change a current that is applied to and/or received by the one or more solenoid devices. For example, the controller may detect an emanate fall of the object and may transmit the signal before the fall occurs to lock the fall protection system 400 prior to the fall protection system moving to the locked state due to the mechanical (e.g., rotational) forces acting on the locking components 618A-D.

The change in current that is applied to and/or received by the solenoid devices may cause one or more of the extension members 630 to move between first positions 650 (shown in FIG. 6) and second positions 652 (shown in FIG. 8) in a third direction of movement 802. For example, the extension members 630 in the first positions 650 may be in retracted states, and the extension members 630 in the second positions 652 may be in extended states. Moving the extension members 630 from the first positions 650 to the second positions 652 causes the corresponding locking component 618A-D to rotate in the second direction of rotation 702 and engage one of the engagement features 608A-D of the housing. Optionally, the extension members may be operably coupled with an electrical device and/or system other than a solenoid device. For example, the extension members may be operably coupled with another electrical device and/or system that may control movement of the extension members between retracted and extended states responsive to receiving the signal from the controller 110 of the safety harness system 100.

The fall protection system 400 may change from the unlocked state 600 to the first or second locked states 700, 800 based on to one or more mechanical or electrical inputs. For example, the fall protection system 400 is a dual safety system that may move to a locked position based on either of the mechanical or electrical inputs. The dual safety system may move from the unlocked state to the locked state at a speed that may be faster than a fall protection system that is a single safety system and can only move from the unlocked state to the locked state based on just mechanical inputs. For example, the controller 110 may determine that the speed of movement of the object 104 exceeds the movement threshold before the rotational speed of the rotating device 612 reaches a speed of rotation that causes the locking components 618A-D to rotate to engage with the engagement features of the housing. For example, the signal from the controller 110 may cause the extension members 630 to move to the second positions 652 (e.g., extended states) before the speed of rotation of the rotating device 612 causes the locking components 618A-D to rotate.

For example, the processors may detect an imminent fall of the object, and may transmit the signal to the fall protection system to lock the fall protection system before the object falls. The processors may determine that the object is about to fall, that a fall of the object is about to occur (e.g., within about 10 milliseconds, within about 100 milliseconds, within about 1 second, or the like) before the fall occurs. Changing the locking state with the electrical signal allows the safety harness system to lock the fall protection system at a speed that is faster than the fall protection system locking as a result of the mechanical forces acting on the locking components, and controls an amount of shock the object may experience.

In one or more examples, the controller 110 of the safety harness system 100 may additionally be communicatively coupled with another system, such as an emergency system (e.g., an emergency response or dispatch center, a paramedics group, a fire station, etc.). In addition the controller 110 transmitting the signal to the fall protection system 400 to control an amount of travel of the retractable lanyard 402, the controller 110 may also communicate a signal to the emergency system (not shown) or another off-board system (e.g., a control center of the lift system, a dispatch center, or the like). The signal may include a time stamp associated with a time at which the one or more processors 302 determined that the amount of movement of the object exceeded the movement threshold. Optionally, the signal may include a geographic location of the object 104, the safety harness system 100, the one or more sensors 106A-D, or the like. Optionally, the signal may include information associated with the amount of movement of the object 104 that was detected by the sensors 106A-D (e.g., a rate of speed, a rate of velocity, etc.). In one or more examples, the signal transmitted to the control center and/or the emergency center may provide information to operators at the control center and/or the emergency center to allow the operators to locate the object 104, understand a potential state of health of the object 104, or the like. For example, the signal may be an alert that may notify operators at the control center and/or emergency center that an object 104 has potentially fallen from an elevated location.

FIG. 9 illustrates example of a timeline 900, according to an example of the present disclosure. The timeline 902 extends between a first time 902 and a second time 904. In one example, the length of time between the first and second times 902, 904 may be associated with a single use of the safety harness system 100. For example, the first time 902 may be based on the time at which the safety harness system 100 is coupled with the object 104, and the second time 904 may be based on the time at which the safety harness system 100 is removed from the object 104. In another example, the first time 902 may be based on the time at which the safety harness system 100 (and object 104 coupled thereto) moves to an elevated position above a first determined elevated height, and the second time 904 may be based on the time at which the safety harness system 100 (and object 104) move to an elevated position below the first determined elevated height. In another example, the first time 902 may be based on a time that the safety harness system 100 is coupled with a lift system via the anchoring component 406 of the fall protection system, and the second time 904 may be based on a time that the safety harness system 100 is decoupled from the lift system. Optionally, the first and second times 902, 904 of the timeline 900 may be based on any alternative operating state, operating mode, time, position, or the like, of the safety harness system.

In one or more examples, the processors 302 may receive a first set of data from the one or more sensors 106A-D that is associated with a first time range 906. The one or more processors 302 may determine if movement of the object 104 exceeds the movement threshold based on the movement of the object 104 that occurs within the first time range 906. For example, the processors may ignore some of the data that is associated with a time outside of the first time range 906 when determining if the amount of movement exceeds the movement threshold.

In one or more examples, the processors 302 may receive a second set of data from the sensors 106A-D that is associated with a second time range 908. The second set of data may be obtained during second time range 908. In one example, the one or more processors 302 may compare the first set of data with the second set of data, and determine that the amount of movement of the object 104 exceeds the movement threshold based at least in part on the comparison between the first and second sets of data.

In one example, the one or more processors 302 may receive historical data that may be stored within the memory 310 of the controller 110. The one or more processors 302 may compare the first set of data and/or the second set of data with the stored historical data, and may determine that the amount of movement of the object exceeds the movement threshold based at least in part comparison between the stored historical data and the first and/or second sets of data.

Referring to FIGS. 1-9, examples of the subject disclosure provide systems and methods that allow large amounts of data to be quickly and efficiently analyzed by a computing device. For example, the controller 110 can analyze various aspects of the safety harness system 100, the object 104 coupled with the straps 102, the lift system (not shown) to which the safety harness system 100 is coupled, and the like. As such, large amounts of data, which may not be discernable by human beings, are being tracked and analyzed. The vast amounts of data are efficiently organized and/or analyzed by the controller 110, as described herein. The controller 110 analyzes the data in a relatively short time in order to quickly and efficiently determine the state and/or position of the object 104. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, all or part of the systems and methods described herein may be or otherwise include an artificial intelligence (AI) or machine-learning system that can automatically perform the operations of the methods also described herein. For example, the controller 110 can be an artificial intelligence or machine learning system. These types of systems may be trained from outside information and/or self-trained to repeatedly improve the accuracy with how data is analyzed. Over time, these systems can improve by determining such information with increasing accuracy and speed, thereby significantly reducing the likelihood of any potential errors. For example, the AI or machine-learning systems can learn and determine the performance capabilities of different objects 104 that may be coupled with the safety harness system 100, anticipated or expected movements or motions of the objects 104, and the like, and automatically determine when an amount of movement or motion of the object exceeds an allowable movement or motion threshold. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and retrained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of an allowable amount of movement or motion of the object 104 coupled with the safety harness system 100. The training minimizes conflicts and interference by performing an iterative training algorithm, in which the systems are retrained with an updated set of data (for example, data received before, during, and/or after each use of the safety harness system 100) and based on the feedback examined prior to the most recent training of the systems. This provides a robust analysis model that can better determine situational information in a cost effective and efficient manner.

Further, the disclosure comprises examples according to the following clauses:

Clause 1: a safety harness system, comprising:
one or more strap configured to be operably coupled with an object;
one or more sensors operably coupled with the one or more straps, the one or more sensors detecting movement of the object; and
one or more processors configured to be operably coupled with the one or more straps and configured to receive data from the one or more sensors associated with the movement of the object,
wherein the one or more processors may determine that an amount of movement of the object exceeds a movement threshold, and
the one or more processors may transmit a signal responsive to the one or more processors determining that the amount of movement exceeds the movement threshold.

Clause 2: the safety harness system of clause 1, wherein the one or more processors may be operably coupled with a fall protection system, the one or more processors may transmit the signal to the fall protection system responsive to determining that the amount of movement of the object exceeds the movement threshold.

Clause 3: the safety harness system of clause 2, wherein the signal is configured to control movement of an extension member of the fall protection system to move the extension member between a first position and a second position, wherein the extension member moving between the first position and the second position changes a state of a locking component of the fall protection system between an unlocked state and a locked state.

Clause 4: the safety harness system of clause 3, wherein the one or more straps are configured to be operably coupled with the fall protection system via a retractable lanyard extending between the one or more straps and the fall protection system, wherein the signal is configured to change the state of the locking component of the fall protection system to control an amount of travel of the retractable lanyard.

Clause 5: the safety harness system of clauses 1-4, wherein the one or more processors are configured to receive a first set of data from the one or more sensors, the first set of data associated with the movement of the object within a first time range.

Clause 6: the safety harness system of clause 5, wherein the one or more processors are configured to determine that the amount of movement of the object exceeds the movement threshold based at least in part on the first set of data received from the one or more sensors.

Clause 7: the safety harness system of clause 5, wherein the one or more processors are configured to receive a second set of data from the one or more sensors, the second set of data associated with the movement of the object within a second time range, wherein the one or more processors are configured to compare the first set of data with the second set of data, and the one or more processors are configured to determine that the amount of movement of the object exceeds the movement threshold based at least in part on the comparison between the first set of data and the second set of data.

Clause 8: the safety harness system of clauses 1-7, further comprising a memory configured to store historical data detected by the one or more sensors, wherein the one or more processors are configured to determine that the amount of movement of the object exceeds the movement threshold based at least in part on the historical data.

Clause 9: the safety harness system of clauses 1-8, wherein the one or more processors are configured to transmit the signal to an emergency system.

Clause 10: the safety harness system of clauses 1-9, wherein the signal includes one or more of a location of the one or more sensors or a time stamp associated with a time at which the one or more processors determined that the amount of the movement of the object exceeded the movement threshold.

Clause 11: the safety harness system of clauses 1-10, wherein the one or more processors are configured to determine that the amount of the movement of the object within a determined time range exceeds a movement rate threshold.

Clause 12: the safety harness system of clauses 1-11, wherein the one or more processors are configured to transmit the signal via one or more of a wired connection or a wireless connection between the one or more processors and another device.

Clause 13: a method, comprising:
detecting movement of an object operably coupled with one or more straps of a safety harness system;
determining that an amount of the movement of the object exceeds a movement threshold; and
transmitting a signal responsive to determining that the amount of the movement of the object exceeds the movement threshold, wherein the transmitting of the signal includes controlling operation of a fall protection system based at least in part on the signal.

Clause 14: the method of clause 13, further comprising controlling a locking component of the fall protection system to change a state of the locking component between an unlocked state and a locked state responsive to the transmitting of the signal.

Clause 15: the method of clause 14, wherein the one or more straps of the safety harness system are configured to be operably coupled with the fall protection system via a retractable lanyard extending between the one or more straps and the fall protection system, and further comprising changing the state of the locking component of the fall protection system based on the signal to control an amount of travel of the retractable lanyard.

Clause 16: the method of clauses 13-15, further comprising:
receiving a first set of data associated with the movement of the object within a first time range; and
determining that the amount of the movement of the object exceeds the movement threshold based at least in part on the first set of data.

Clause 17: the method of clause 16, further comprising:
receiving a second set of data associated with the movement of the object within a second time range;
comparing the first set of data with the second set of data; and
determining that the amount of movement of the object exceeds the movement threshold based at least in part on the comparison between the first set of data and the second set of data.

Clause 18: the method of clauses 13-17, further comprising one or more of wirelessly transmitting the signal or transmitting the signal via a wired connection.

Clause 19: a safety harness system, comprising:
one or more straps configured to be operably coupled with an object, the one or more straps configured to be operably coupled with a fall protection system;
one or more sensors configured to be operably coupled with one or more straps, the one or more sensors configured to detect movement of the object; and
one or more processors configured to receive data from the one or more sensors associated with the detected movement of the object, the one or more processors configured to be electrically coupled with the fall protection system,
wherein the one or more processors are configured to determine that an amount of movement of the object exceeds a movement threshold, and
wherein the one or more processors are configured to transmit a signal to the fall protection system responsive to determining that the amount of movement of the object exceeds the movement threshold, wherein the signal is configured to change a state of a locking component of the fall protection system between an unlocked state and a locked state.

Clause 20: the safety harness system of clause 19, wherein the one or more straps are configured to be operably coupled with the fall protection system via a retractable lanyard extending between the one or more straps and the fall protection system, wherein the signal is configured to change the state of the locking component of the fall protection system to control an amount of travel of the retractable lanyard.

As described herein, examples of the present disclosure provide systems and methods for detecting movement of an object operably coupled with straps of a safety harness system, and controlling operation of a fall protection system based on a determination that an amount of movement of the object exceeds a threshold to provide safety to the object (e.g., an operator or other object) that is at an elevated position. The safety harness system determines that the object has moved too much, too quickly, or the like, and automatically controls operation of a locking component of the fall protection system to change the state of the fall protection system from an unlocked state to a locked state to prohibit the operator or object coupled with the safety harness system from falling beyond an allowable distance.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A safety harness system, comprising:
one or more straps configured to be operably coupled with an object;
one or more sensors configured to be operably coupled with the one or more straps, the one or more sensors configured to detect movement of the object; and
one or more processors configured to be operably coupled with the one or more straps and configured to receive data from the one or more sensors associated with the movement of the object;
wherein the one or more processors are configured to determine that an amount of movement of the object exceeds a movement threshold, and
wherein the one or more processors are configured to transmit a signal responsive to the one or more processors determining that the amount of movement of the object exceeds the movement threshold.

2. The safety harness system of claim 1, wherein the one or more processors are configured to be operably coupled with a fall protection system, wherein the one or more processors are configured to transmit the signal to the fall protection system responsive to determining that the amount of movement of the object exceeds the movement threshold.

3. The safety harness system of claim 2, wherein the signal is configured to control movement of an extension member of the fall protection system to move the extension member between a first position and a second position, wherein the extension member moving between the first position and the second position changes a state of a locking component of the fall protection system between an unlocked state and a locked state.

4. The safety harness system of claim 3, wherein the one or more straps are configured to be operably coupled with the fall protection system via a retractable lanyard extending between the one or more straps and the fall protection system, wherein the signal is configured to change the state of the locking component of the fall protection system to control an amount of travel of the retractable lanyard.

5. The safety harness system of claim 1, wherein the one or more processors are configured to receive a first set of data from the one or more sensors, the first set of data associated with the movement of the object within a first time range.

6. The safety harness system of claim 5, wherein the one or more processors are configured to determine that the amount of movement of the object exceeds the movement threshold based at least in part on the first set of data received from the one or more sensors.

7. The safety harness system of claim 5, wherein the one or more processors are configured to receive a second set of data from the one or more sensors, the second set of data associated with the movement of the object within a second time range, wherein the one or more processors are configured to compare the first set of data with the second set of data, and the one or more processors are configured to determine that the amount of movement of the object exceeds the movement threshold based at least in part on the comparison between the first set of data and the second set of data.

8. The safety harness system of claim 1, further comprising a memory configured to store historical data detected by the one or more sensors, wherein the one or more processors are configured to determine that the amount of movement of the object exceeds the movement threshold based at least in part on the historical data.

9. The safety harness system of claim 1, wherein the one or more processors are configured to transmit the signal to an emergency system.

10. The safety harness system of claim 1, wherein the signal includes one or more of a location of the one or more sensors or a time stamp associated with a time at which the one or more processors determined that the amount of movement of the object exceeded the movement threshold.

11. The safety harness system of claim 1, wherein the one or more processors are configured to determine that the amount of movement of the object within a determined time range exceeds a movement rate threshold.

12. The safety harness system of claim 1, wherein the one or more processors are configured to transmit the signal via one or more of a wired connection or a wireless connection between the one or more processors and another device.

13. A method, comprising:
detecting movement of an object operably coupled with one or more straps of a safety harness system;
determining that an amount of movement of the object exceeds a movement threshold; and
transmitting a signal responsive to determining that the amount of movement of the object exceeds the movement threshold, wherein the transmitting of the signal includes controlling operation of a fall protection system based at least in part on the signal.

14. The method of claim 13, further comprising controlling a locking component of the fall protection system to change a state of the locking component between an unlocked state and a locked state responsive to the transmitting of the signal.

15. The method of claim 14, wherein the one or more straps of the safety harness system are configured to be operably coupled with the fall protection system via a retractable lanyard extending between the one or more straps and the fall protection system, and further comprising changing the state of the locking component of the fall protection system based at least in part on the signal to control an amount of travel of the retractable lanyard.

16. The method of claim 13, further comprising:
receiving a first set of data associated with the movement of the object within a first time range; and
determining that the amount of movement of the object exceeds the movement threshold based at least in part on the first set of data.

17. The method of claim 16, further comprising:
receiving a second set of data associated with the movement of the object within a second time range;
comparing the first set of data with the second set of data; and
determining that the amount of movement of the object exceeds the movement threshold based at least in part on the comparison between the first set of data and the second set of data.

18. The method of claim 13, further comprising one or more of wirelessly transmitting the signal or transmitting the signal via a wired connection.

19. A safety harness system, comprising:
one or more straps configured to be operably coupled with an object, the one or more straps configured to be operably coupled with a fall protection system;
one or more sensors configured to be operably coupled with the one or more straps, the one or more sensors configured to detect movement of the object; and
one or more processors configured to be operably coupled with the one or more straps, the one or more processors configured to receive data from the one or more sensors associated with the detected movement of the object, the one or more processors configured to be electrically coupled with the fall protection system,
wherein the one or more processors are configured to determine that an amount of movement of the object exceeds a movement threshold, and
wherein the one or more processors are configured to transmit a signal to the fall protection system responsive to determining that the amount of movement of the object exceeds the movement threshold, wherein the signal is configured to change a state of a locking component of the fall protection system between an unlocked state and a locked state.

20. The safety harness system of claim 19, wherein the one or more straps are configured to be operably coupled with the fall protection system via a retractable lanyard extending between the one or more straps and the fall protection system, wherein the signal is configured to change the state of the locking component of the fall protection system to control an amount of travel of the retractable lanyard.
